(19) United States
(12) Patent Application Publication
(10) Pub. No.: US 2020/0134974 A1
(43) Pub. Date: Apr. 30, 2020

(54) GAMING MACHINE, INFORMATION PROCESSING DEVICE, AND GAME SYSTEM

(71) Applicant: Universal Entertainment Corporation, Tokyo (JP)

(72) Inventor: Jun HAISHIMA, Tokyo (JP)

(21) Appl. No.: 16/595,644

(22) Filed: Oct. 8, 2019

(30) Foreign Application Priority Data
Oct. 30, 2018 (JP) 2018-203902

(51) Int. Cl. G07F 17/32; G07F 17/34

(52) U.S. Cl. CPC G07F 17/3258; G07F 17/34

(57) ABSTRACT

A gaming machine includes: an insertion part capable of inserting a plurality of types of game values into a game; an insertion information storage part configured to store the type of the inserted game value and an integrated value of an inserted amount of each type at each game time point as insertion information; a game execution part that executes the game according to the inserted game value; a payout information storage part that stores an integrated value of a prize amount at each game time point as payout information; a prize amount ratio calculation part that calculates a ratio of each type of the inserted game value to a prize amount of each game executed in the gaming machine based upon the insertion information and the payout information; and an output part that outputs information on the calculated prize amount ratio.

### CROSS-REFERENCE TO RELATED APPLICATION

This application claims the benefit of Japanese Pat. App. No. 2018-203902, filed Oct. 30, 2018, which application is incorporated herein by reference in its entirety.

### FIELD OF THE INVENTION

The present invention relates generally to a slot machine, an information processing device, and a game system in a game hall such as, for example, a casino, and the like.

### BACKGROUND OF THE INVENTION

In a related art, known is a slot machine that displays a plurality of symbols in a stopped state after displaying the plurality of symbols in a scrolled manner, and provides a game value (for example, a coin) based upon a combination of the symbols in the stopped state.

Disclosed is a slot machine capable of allowing a player to feel an attractive payout rate by advancing a game while impressing the player that the game is in an advantageous state (refer to US-A-2012-0115571).

### BRIEF SUMMARY OF THE INVENTION

Meanwhile, in the slot machine described above, as a game value which can be inserted into the slot machine for playing a game, there are cash or a point, and the like previously distributed for promotion. The point is previously written to an information card which can be inserted into the slot machine and is used for playing the game in the slot machine into which the information card is inserted.

The slot machine can start a game by inserting cash or a point. A dividend (prize amount) generated as a result of the game is paid out to a player.

As described above, in the slot machine of the related art, the cash or the point distributed for promotion can be used as a game value to be inserted, and a player can play a game even when the player inserts any of these game values.

In the above-described slot machine, all the prizes obtained when the game is played by inserting the cash or the point distributed for promotion are paid back to the player as the same type of the game value.

Specifically, even when a game is a game played by inserting any type of game medium (cash or point), since the prize to be awarded to a player as a result of the game is paid out as cash or a printed matter printed by a ticket printer, and the like, it is not possible to distinguish whether the amount of the paid-out game value is a prize of the game played by inserting the cash or the point, or not possible to distinguish the breakdown thereof.

The present invention has been made in consideration of the above-described circumstances, and an object thereof is to provide a gaming machine, an information processing device, and a game system capable of obtaining a ratio of each type of an inserted game value to a paid-out prize amount.

A gaming machine of the present invention capable of playing a game according to an inserted game value, the machine including: an insertion part capable of inserting a plurality of types of game values into a game; an insertion information storage part configured to store the type of the inserted game value and an integrated value of an inserted amount of each type at each game time point as insertion information; a game execution part that executes the game according to the inserted game value; a payout information storage part configured to store an integrated value of a prize amount at each game time point as payout information; a prize amount ratio calculation part that calculates a ratio of each type of the inserted game value to a prize amount of each game executed in the gaming machine based upon the insertion information and the payout information; and an output part that outputs information on the calculated prize amount ratio.

According to the above-described configuration, it is possible to obtain the ratio of each type of the inserted game value to the paid-out prize amount.

According to the above-described configuration, the gaming machine of the present invention includes a selection part capable of selecting one or more types of the inserted game values and selecting an inserted amount for each of the selected types, wherein the prize amount ratio calculation part stores an integrated value of an amount of each type at each game time point for each type of the game value selected in the selection part as the insertion information.

According to the above-described configuration, in a configuration in which the plurality of types of game values can be inserted, it is possible to obtain the ratio of each type of the inserted game value to the paid-out prize amount.

According to the above-described configuration of the gaming machine of the present invention, the prize amount ratio calculation part calculates the sum of the inserted amounts of all types of the game values inserted for one game and a prize generated in the one game based upon a difference between integrated values of the inserted game value before and after the one game, and a difference between integrated values of the prize amount before and after the one game, and calculates a ratio of each type of the inserted game value to the prize amount of the game executed in the gaming machine based upon the calculated sum of the inserted amounts of all types of the game value, the prize amount, and the insertion information.

According to the above-described configuration, the amount of the game value inserted for one game is calculated by the difference between the integrated values of the game value before and after one game, and based upon the amount inserted for one game and the prize amount generated in the one game, it is possible to obtain the ratio of each type of the inserted game value to the paid-out prize amount.

According to the above-described configuration of the gaming machine of the present invention, the prize amount ratio calculation part calculates an amount of each type of the inserted game value which accounts for the prize amount of the game by multiplying the calculated ratio of each type of the inserted game value to the prize amount of the game executed in the gaming machine by the sum of the inserted amounts of all types of the game values inserted for the one game.

According to the above-described configuration, it is possible to obtain the amount of each type of the inserted game value which accounts for the paid-out prize amount.

An information processing device of the present invention connected to be capable of transmitting and receiving information to and from a gaming machine capable of playing a game according to an inserted game value, the device including: an insertion part capable of inserting a plurality of types of game values into a game; a prize amount ratio calculation part that calculates a ratio of each type of the inserted game value to a prize amount of each game executed in the gaming machine based upon the type of the inserted game value and an integrated inserted value of an inserted amount of each type at each game time point, and an integrated payout value of a prize amount at each game time point; and an output part that outputs information on the calculated prize amount ratio.

According to the above-described configuration, it is possible to obtain the ratio of each type of the inserted game value to the paid-out prize amount.

A game system of the present invention includes: a gaming machine capable of playing a game according to an inserted game value; and an information processing device connected to be capable of transmitting and receiving information to and from the gaming machine, wherein the gaming machine includes: a game execution part that executes a game; and an interface capable of transmitting and receiving information to and from the information processing device, and the information processing device includes: an insertion part capable of inserting a plurality of types of game values into a game; a prize amount ratio calculation part that calculates a ratio of each type of the inserted game value to a prize amount of each game executed in the gaming machine based upon the type of the inserted game value and an integrated inserted value of an inserted amount of each type at each game time point, and an integrated payout value of a prize amount at each game time point; and an output part that outputs information on the calculated prize amount ratio.

According to the above-described configuration, it is possible to obtain the ratio of each type of the inserted game value to the paid-out prize amount in the game system.

The present invention provides a gaming machine, an information processing device, and a game system capable of obtaining a ratio of each type of an inserted game value to a paid-out prize amount.

### BRIEF DESCRIPTION OF THE DRAWINGS

FIGS. 1A and 1B are diagrams illustrating an overall configuration of a casino system and a configuration of an information processing device according to an embodiment of the present invention;

FIG. 2 is a perspective view illustrating a configuration of a slot machine according to an embodiment of the present invention;

FIG. 3 is a perspective view illustrating a PTS terminal incorporated in the slot machine according to the embodiment of the present invention;

FIG. 4 is a block diagram illustrating an internal configuration of the slot machine according to the embodiment of the present invention;

FIG. 5 is a block diagram illustrating a configuration of the PTS terminal according to the embodiment of the present invention;

FIG. 6 is a flowchart illustrating slot machine control processing according to an embodiment of the present invention; and

FIG. 7 is a flowchart illustrating prize amount calculation processing by a PTS terminal according to an embodiment of the present invention.

### DETAILED DESCRIPTION OF THE PREFERRED EMBODIMENT

[Overall Configuration]

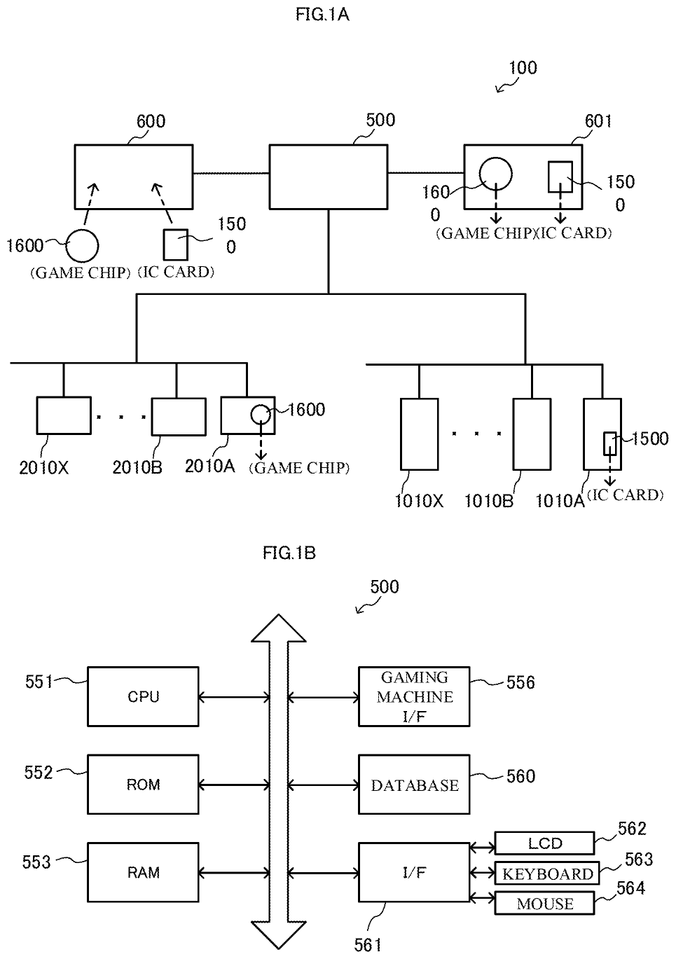

FIG. 1A is a block diagram illustrating a casino system 100 according to an embodiment of the present invention. As illustrated in FIGS. 1A and 1B, for example, the casino system 100 is formed of a plurality of gaming machines (for example, slot machines 1010A, 1010B, and the like) installed in game facilities such as a casino, and the like, a plurality of game tables (for example, game tables 2010A, 2010B, and the like), and a hotel server 500 communicably connected thereto in a bidirectional manner.

A device for issuing a member information card and a game chip 601 is connected to the hotel server 500, and in the device for issuing the member information card and the game chip 601, an IC card 1500 is issued as the member information card and the game chip 1600 is issued.

In the member information card, unique information card identification information (information card number (No)) for specifying the IC card 1500 is stored, and in the hotel server 500, member information is stored in a member database in association with each information card number. A player who becomes a member registers personal information (for example, name, address, telephone number, nationality, passport number, personal identification information for identifying an individual issued by a government, and the like) in the member database as the member information, thereby, in the member database, the personal information is registered in association with the information card identification information (information card number) for specifying the information card.

The information card to which the information card number is imparted is issued from the device for issuing the member information card and the game chip 601, and the issued information card is used when a player registered as a member plays a game in the slot machines 1010A, 1010B, and the like.

The game chip 1600 is issued from the device for issuing the member information card and the game chip 601, and is used when a game is played on the game tables 2010A, 2010B, and the like.

The hotel server 500 is connected to a cashier 600 for performing cash conversion based upon the IC card 1500 (member information card, non-member information card) or the game chip.

After the game, a player playing a game by using the IC card 1500 as the member information card or the non-member information card (described later) inserts the IC card 1500 paid out from the slot machines 1010A, 1010B, and the like into a card reader of the cashier 600, such that a currency corresponding to the balance owned by the player stored in the information card identification information (information card number) of the IC card 1500 is paid out to the player. In the embodiment, information on the balance associated with the information card is written directly to the IC card 1500, but the present invention is not limited thereto. For example, the hotel server 500 may store the balance information in association with the information card number. Here, the balance information being stored in the memory of the hotel server 500 may be read out corresponding to the card number of the IC card 1500 read by the card reader of the cashier 600, after which the currency may be paid back based upon the read balance information.

In the IC card 1500 (member information card and nonmember information card), four types of game value storage areas are provided as game value information indicating an amount of the game value respectively provided for the BET of a game. Specifically, the four types of game value storage areas include: a first storage area AR1 for storing a first game value which is credited as cash and is permitted to be used only in the game; a second storage area AR2 for storing a second game value which is credited as cash and can be converted into cash without playing the game; a third storage area AR3 for storing a third game value which is credited as a game value other than cash, cannot be basically converted into cash, and is permitted to be used only in the game; and a fourth storage area AR4 for storing a fourth game value which is credited as a game value other than cash, cannot be basically converted into cash, and is permitted to be used not only for the game but also for various services in the facility (so-called bonus credit). Hereinafter, information representing the type and the amount of the game value stored in the first storage area AR1 will be referred to as first game value information; information representing the type and the amount of the game value stored in the second storage area AR2 will be referred to as second game value information; information representing the type and the amount of the game value stored in the third storage area AR3 will be referred to as third game value information; and information representing the type and the amount of the game value stored in the fourth storage area AR4 will be referred to as fourth game value information. The pieces of game value information written in the information card will be collectively referred to as the balance information.

In the non-member information card of the IC card 1500, a player who is not registered as a member first inserts a currency into any one of the slot machines 1010A, 1010B, and the like and plays a game, after which a dividend (prize money) provided to the player as a result of the game and an amount corresponding to the number of credits remaining after making a BET with respect to an inserted amount are written to the non-member information card (IC card 1500), and the non-member information card is newly paid out from the slot machines 1010A, 1010B, and the like in which the play is performed. The player inserts the newly paid-out non-member information card (IC card 1500) into other slot machines 1010A, 1010B, and the like, thereby a new game can be played by using the number of credits corresponding to the balance information written to the non-member information card. When the non-member information card (IC card 1500) is inserted into any one of the slot machines 1010A, 1010B, and the like and thus a game is played, a game value based upon the number of credits such as the dividend (prize money) given as a result of the game play is written to the non-member information card (IC card 1500) inserted into the slot machines 1010A, 1010B, and the like when the game is played as the balance information. That is, the balance information of the non-member information card is updated and the non-member information card is paid out. Accordingly, a player who is not registered as a member can play a game in the plurality of slot machines 1010A, 1010B, and the like while using one non-member information card.

Even when the inserted IC card 1500 is the member information card issued to the player registered as the member, the balance information is updated and paid out with respect to the inserted member information card in the same manner as that of the non-member information card.

When a player playing a game on the game tables 2010A, 2010B, and the like by using a game chip presents the game chip as a dividend (prize money) received from a dealer after the game to the cashier 202, a currency corresponding to the game chip can be received.

In the embodiment, the balance information associated with the information card is directly written to the IC card 1500, but is not limited thereto, and for example, the hotel server 500 may store the balance information in association with the information card number. Here, the balance information being stored in the memory of the hotel server 500 may be read out corresponding to the card number of the IC card 1500 read by the card reader of the cashier 600, and the currency may be paid back based thereupon.

FIG. 1B is a block diagram illustrating a configuration of the hotel server 500. As illustrated in FIG. 1B, the hotel server 500 includes a configuration in which a central processing unit (CPU) 551, a read only memory (ROM) 552, a random access memory (RAM) 553, a gaming machine I/F 556, a database 560, an I/F 561, and the like are connected to a bus, and a liquid crystal display (LCD) 562, a keyboard 563, a mouse 564, and the like are connected to the bus via the I/F 561. In the database 560, the member information associated with the information card number, the balance information and the game history information associated with the IC card 1500 issued to a game value member being stored in the information card, the balance information and the game history information associated with the IC card 1500 issued to the non-member, and the like are stored.

[Overall Configuration of Slot Machine]

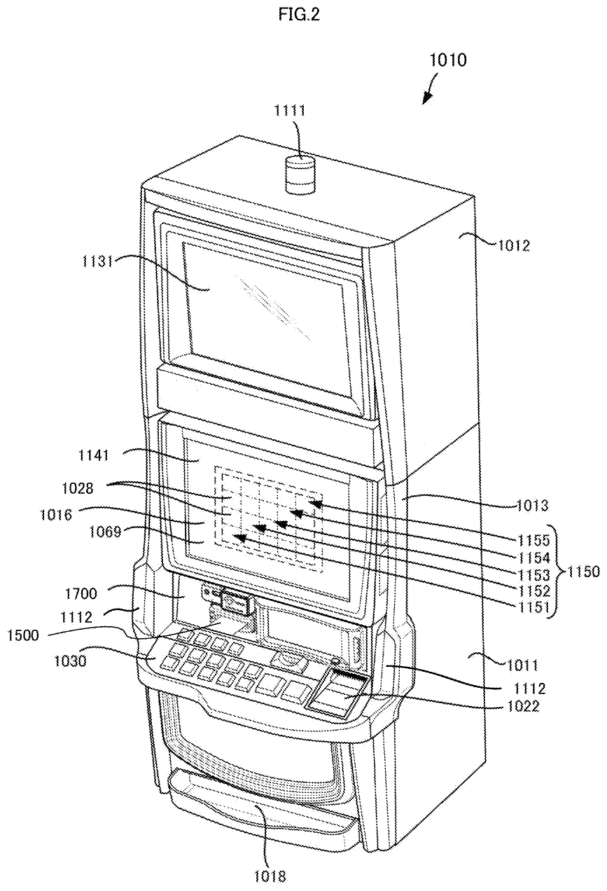

FIG. 2 is a perspective view illustrating an external appearance of the slot machine 1010 as a gaming machine according to an embodiment of the present invention.

In the slot machine 1010, as a game medium, the IC card 1500 and a bill or electronic valuable information corresponding to the game values thereof are used. In the embodiment, when a dividend awarded to a player as a result of the game is generated in the slot machine 1010, the amount of the dividend is stored in the IC card 1500 and the IC card 1500 is paid out.

That is, when the IC card 1500 is inserted into a card unit 1741 of a PTS terminal 1700 provided in the slot machine 1010 by the player, the balance of the stored game value is read from the inserted IC card 1500 and is used for playing a game, and when a dividend is generated as a result of the game, the dividend is configured to be stored in the IC card 1500 of the player being inserted into the card unit 1741. When the game value is inserted in a state where the IC card 1500 is not inserted (that is, when the game value is inserted by a medium such as a bill, and the like other than the IC card 1500), the dividend generated as a result of the game is paid out by storing the dividend in the unused IC card 1500 prepared in a card stacker 1742 of the card unit 1741.

The slot machine 1010 includes a cabinet 1011, a top box 1012 installed on the upper side of the cabinet 1011, and a main door 1013 provided on the front surface of the cabinet 1011.

The main door 1013 includes a symbol display device 1016 referred to as a lower image display panel 1141. The symbol display device 1016 is formed of a transparent liquid crystal panel. In the screen on which the symbol display device 1016 is displayed, a display window 1150 is provided in a central part thereof. The display window 1150 is formed of 20 pieces of display blocks 1028 in five columns and four rows. The four pieces of display blocks 1028 in each column form pseudo reels 1151 to 1155 and are rotated according to an operation of a player. Each of the pseudo reels 1151 to 1155 can be rearranged in such a manner that the four pieces of display blocks 1028 are moved and displayed in a downward direction while changing the speed as a whole such that a symbol displayed on each of the display blocks 1028 is rotated in a vertical direction and then is stopped.

Here, the “rearranged” means a state in which the symbol is arranged again after the arrangement of the symbol is released. The “arrangement” means that the symbol is in a state of being visually confirmable by a player. The slot machine 1010 executes a so-called slot game in which a dividend corresponding to a winning combination is provided depending on the arrangement state of the symbol based upon the stop state of the rotating pseudo reels 1151 to 1155.

In the embodiment, it is described that the slot machine 1010 is a so-called video slot machine, but the slot machine 1010 of the present invention may adopt a so-called mechanical reel or may be substituted for some of the pseudo reels 1151 to 1155.

A touch panel 1069 is provided on the front surface of the symbol display device 1016, and a player can input various instructions by operating the touch panel 1069. An input signal is transmitted from the touch panel 1069 to a main CPU.

An upper image display panel 1131 is provided on the front surface of the top box 1012. The upper image display panel 1131 is formed of a liquid crystal panel and forms a display. The upper image display panel 1131 displays an image relating to a performance, an image showing an introduction of the contents of the game and the description of a rule. The top box 1012 is provided with a lamp 1111.

A number-of-credits display part (not illustrated) is displayed at the upper part of the display window 1150, and the current number of credits is displayed thereon. Here, the “credit” is a virtual game medium on a game used when a player makes a BET. The total number of credits currently owned by the player is displayed on the number-of-credits display part.

A fractional cash display part (not illustrated) is displayed at the lower part of the number-of-credits display part. The fractional cash display part displays fractional cash. The “fractional cash” means cash that is not converted into the credit because the inserted amount is not sufficient.

The IC card 1500 is inserted into the PTS terminal 1700 which will be described later; the number of credits stored in the IC card 1500 is displayed on the number-of-credits display part; and the fractional cash stored in the IC card 1500 is displayed on the fractional cash display part. When a user of the IC card 1500 is a member, these numerical values are stored in a member management server (not illustrated) in association with an identification code of the member card.

Here, the IC card is a non-contact IC card and incorporates an integrated circuit (IC) for recording and computing various data such as a credit, and the like, and is capable of performing, for example, short-range radio communication using radio frequency identification (RFID) technology such as near field communication (NFD). The player can own the credit related data by using the IC card 1500 and can freely carry the IC card 1500 between different slot machines. Then, the IC card 1500 is inserted into the PTS terminal 1700 of the slot machine 1010, thereby the player can play a game such as a unit game, and the like in the slot machine 1010 by using the credit related data (amount data) stored in the IC card 1500.

The player can store cash such as a coin and a bill in the IC card 1500 as cash data from a machine installed in the game hall.

At the lower part of the lower image display panel 1141, the PTS terminal 1700 is incorporated in the cabinet 1011. Speakers 1112 are respectively provided on the left and right sides of the PTS terminal 1700 and the lamp 1111 is provided at the upper part of the top box 1012. In the slot machine 1010, the performance of the unit game is executed by the display of an image by the upper image display panel 1131, the output of sound by the speaker 1112, and the output of light by the lamp 1111. The PTS terminal 1700 is provided in the slot machine 1010 as accessory or internally.

[Configuration of PTS Terminal]

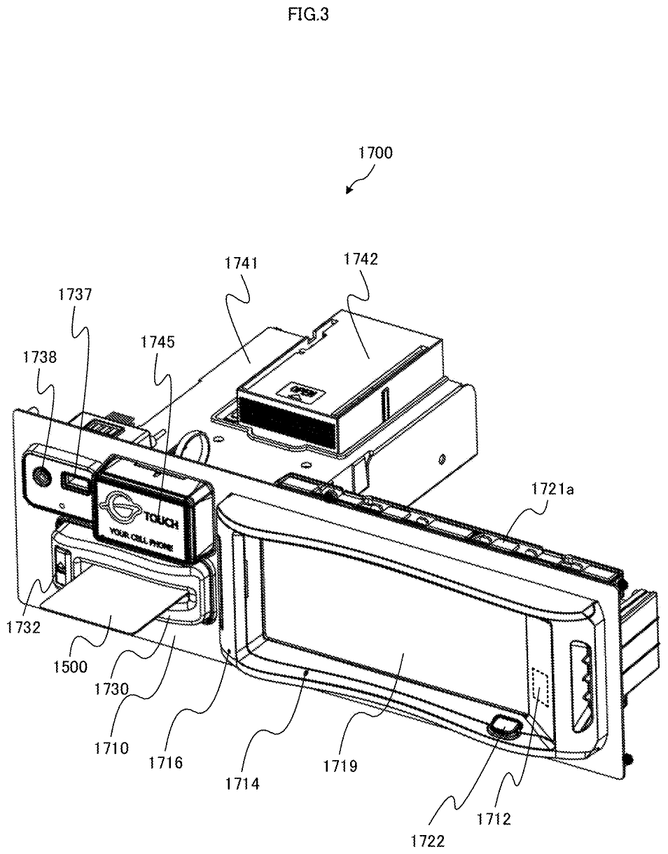

FIG. 3 is a diagram illustrating the PTS terminal 1700 incorporated in the slot machine 1010. The PTS terminal 1700 can be incorporated into various types of gaming machines of various manufacturers by performing data exchange by using a data interface common between the gaming machines.

The PTS terminal 1700 includes a panel 1710; each part disposed on the front surface of the panel 1710 is visually recognized by the player; and a member disposed on the rear surface of the panel 1710 is stored inside the slot machine 1010 such that the member cannot be seen by the player.

An LCD 1719 including a touch panel function is provided on the right side of the front surface of the panel 1710. The LCD 1719 displays, for example, information on the member and information for the member, and a screen size is 6.2 inches (about 15.7 cm). An LCD cover is provided around the LCD 1719. In the embodiment, the LCD 1719 is configured to include the touch panel function, but the instruction of the player may be inputted by another input device such as a keyboard and a mouse.

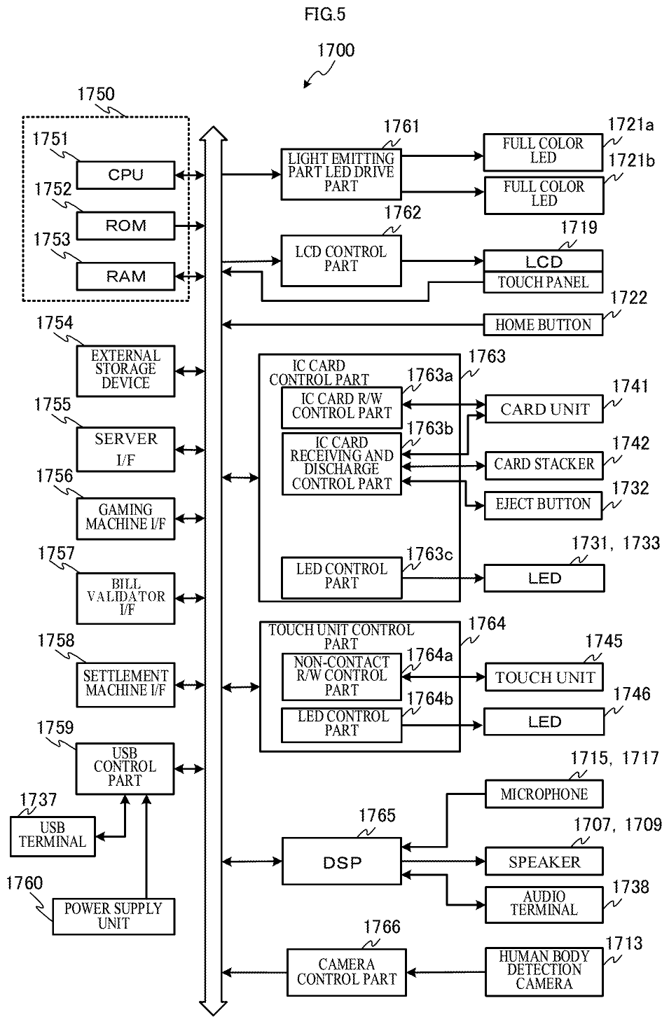

A full color LED 1721a and a full color LED 1721b (in FIG. 5) are configured to be capable of performing light emission contributing to a warning of a fraudulent act.

An imaging window 1712 is provided on the right side of the LCD 1719. A human body detection camera 1713 disposed inside the LCD cover 1719a or on the back side of the panel 1710 captures an image of a player, and the like through the imaging window 1712. The imaging window 1712 may be, for example, a half mirror material to which shield processing such as smoke, and the like is applied.

A card insertion slot 1730 into and from which the IC card 1500 can be inserted and removed is provided at the lower left and front surface of the panel 1710. A card insertion part of the card insertion slot 1730 is provided with a full color LED 1731 (refer to FIG. 5), and it is possible to notify the remaining number of IC cards 1500 accumulated in the card stacker 1742 which will be described later by lighting in a plurality of colors. The card insertion slot 1730 is provided with an eject button 1732, and a red LED 1733 (refer to FIG. 5) provided near the eject button 1732 is turned on so that a position of the eject button 1732 and processing of an eject operation can be understood.

The card unit 1741 and the card stacker 1742 are provided at a position on the back side of the panel 1710 corresponding to the card insertion slot 1730, and the card insertion slot 1730 is configured as a part of the card unit 1741. About 30 pieces of IC cards 1500 can be stored in the card stacker 1742, and when the game is performed by inserting another game value such as a bill, and the like without inserting the IC card 1500, when the settlement of the credit is performed, the IC card 1500 being stored in the card stacker 1742 is configured to be taken out; the dividend (balance) generated as a result of the game is configured to be written to the IC card 1500; and the IC card 1500 is configured to be discharged from the card insertion slot 1730.

Accordingly, in the slot machine 1010 of the embodiment, the dividend or the balance is configured to be stored in the IC card 1500 and is configured to be paid out as a payout method of when the dividend or the balance is generated, regardless of the type of the inserted game medium.

The IC card 1500 being held in the card unit 1741 updates credit information such as the dividend and the balance to be written in the memory by NFC, and the like at the time of settlement of the credit, after which the IC card 1500 is discharged from the card insertion slot 1730. The IC card 1500 is completely stored inside the card unit 1741 while the player plays the unit game.

When the absence of the player is detected by a human body detection camera, and the like even though the IC card 1500 remains at the time of the settlement of the credit, the IC card 1500 can be configured to be stored in the card stacker 1742. Accordingly, for example, when the player leaves the IC card 1500 and leaves his or her seat after knowing that the remaining credit is low, or even when the player simply forgets to take the IC card 1500 and leaves the seat, the IC card 1500 does not remain held in the card unit 1741 for a long time.

A USB terminal 1737 and an audio terminal 1738 are provided on the front upper left side of the panel 1710. The USB terminal 1737 is configured to perform charging, and the like by connecting a USB device to the USB terminal 1737. The audio terminal 1738 is, for example, a four-pole terminal, and a headset is inserted thereinto, such that the user can talk to the other party with a headphone and a microphone. The audio terminal 1738 is configured as a two-pole or a three-pole terminal such that the user also can listen to the sound with the headphone.

A touch unit 1745 is provided on the front surface of the panel 1710 and on the left side of the LCD 1719. The touch unit 1745 includes: a writer that writes data by data communication to an IC device including an IC chip (for example, a non-contact IC card and a mobile phone and a smart phone provided with a communication function by NFC); and an RFID module that can function as a reader that reads the data from the IC device by the data communication. LEDs 1746 (not illustrated) are respectively disposed at four corners of the front surface of the touch unit 1745. In addition to the touch unit 1745, or in place of the touch unit 1745, an information recording medium reader for reading information stored in an information recording medium such as a magnetic card may be provided. Here, the magnetic card can be used as a member card instead of the IC card 1500.

As described above, in the PTS terminal 1700 according to the embodiment of the present invention, various devices including a microphone function, a camera function, a speaker function, a display function, and the like are integrated to form one unit, thereby achieving space saving. Accordingly, for example, when the LCD is directed toward the player in a state where each of the functions is installed as a single part, there is no inconvenience that the speaker cannot be installed toward the player.

In the PTS terminal 1700 according to the embodiment of the present invention, when the IC card 1500 is inserted into the card insertion slot 1730, the content of the IC card 1500 is configured to be read by the card unit 1741 and the entire IC card 1500 is configured to be taken in and held (inside the PTS terminal 1700), however, in addition thereto, the touch unit 1745 is provided, thereby making it possible to further perform the data communication with another IC card, a mobile phone, and a smart phone.

[Circuit Configuration of Slot Machine]

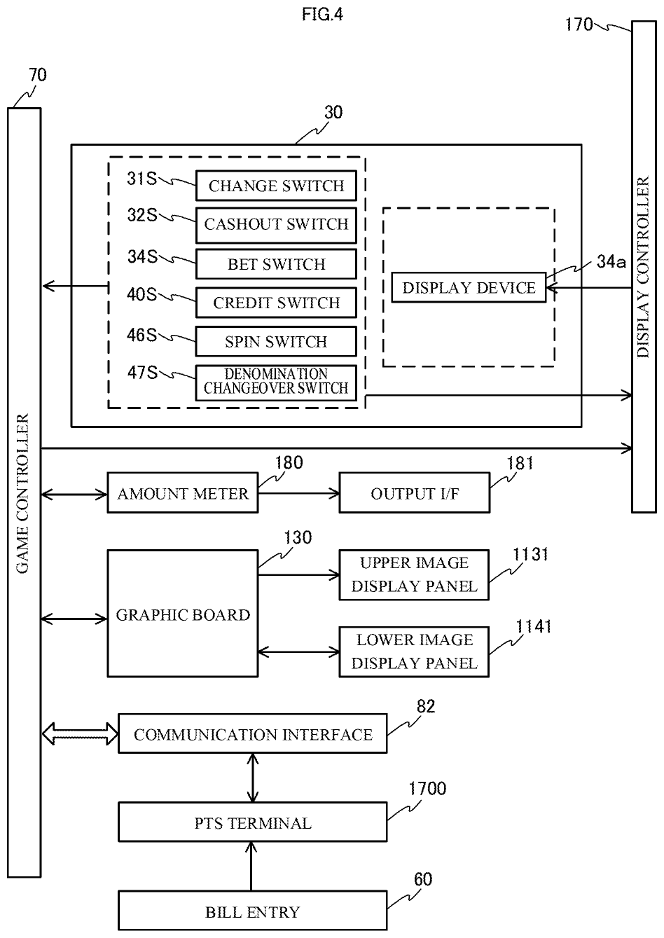

Next, an internal configuration of the slot machine 1010 and a control panel 30 provided in the slot machine 1010 will be described with reference to FIG. 4.

A game controller 70 is provided on a circuit substrate for a game inside the slot machine 1010. A display controller 170 is provided on a circuit substrate for a control panel different from the circuit substrate for the game of the game controller 70 inside the control panel. The game controller 70 and the display controller 170 respectively include: a CPU provided on the circuit substrate for the game and the circuit substrate for the control panel; an electrically erasable and programmable read only memory (EEPROM) for storing programs executed by the CPU and data used for these programs for rewriting to be capable; and a random access memory (RAM) for temporarily storing data when executing the program. The game controller 70 and the display controller 170 are configured in cooperation with the hardware and the software in the storage device described above. The display controller 170 is not limited to being provided separately from the game controller 70, and the game controller 70 may include the function of the display controller 170.

For example, the storage device of the game controller 70 stores the data and the programs used when the CPU operates. For example, when the game controller 70 performs the fetching processing of the above-described game program, game system program, and authentication program from an external storage device, the game controller 70 can store these programs. The storage device of the game controller 70 is provided with a work area used when the programs are executed. For example, an area for storing the number of times of games, the number of BETs, the number of payouts, the number of credits, and the like, and an area for storing symbols (code numbers) determined by lottery are provided.

As described above, the game controller 70 executes the game and controls the symbol display device 1016 so as to rearrange symbols corresponding to the game. As described above, the game controller 70 validates a valid line of the number corresponding to a credit button (not illustrated) that receives an input in a display frame of three rows and five columns formed of a plurality of blocks, and when the same type of symbols of a predetermined number or more are rearranged in the validated valid line, a line dividend corresponding to the type of symbols is awarded. That is, the game controller 70 is configured to control the slot machine by causing the CPUT to execute the game program and the game system program in the storage device. The display controller 170 includes a graphic board and displays a bet amount required for a display device (not illustrated) of the credit button.

The control panel 30 is provided with a CHANGE switch 31S, a CASHOUT switch 32S, a BET switch 34S, a credit switch 40S, a spin switch 46S, and a denomination changeover switch 47S corresponding to the above-described respective buttons. Each switch detects that the corresponding button is pressed by a player and outputs a signal to the game controller 70 and the display controller 170. The game controller 70 controls the bet based on the signals from the respective switches. The display controller 170 transmits the signals from the respective switches to the game controller 70, and the game controller 70 determines contents to be displayed on the display device provided with the button based on the signals, and transmits a determination result to the display controller 170, thereby the determination result is displayed on each button.

The game controller 70 is connected to a graphic board 130, a power supply unit, and a communication interface 82 in addition to the speaker, the touch panel, and the like.

The graphic board 130 controls the display of the images respectively performed by the upper image display panel 1131 and the lower image display panel 1141 based upon the control signal outputted from the game controller 70. The graphic board 130 includes a VDP for generating image data and a video RAM for storing the image data generated by the VDP.

The graphic board 130 includes the video display processor (VDP) for generating the image data based upon the control signal outputted from the game controller 70 and the video RAM for temporarily storing the image data generated by the VDP. The image data used when generating the image data by the VDP are included in the game program of the storage device. The graphic board 130 includes a function of outputting the operation results of various touch icons provided on the lower image display panel 1141 to the game controller 70.

The communication interface 82 performs communication with the PTS terminal 1700 and an external control device. When receiving an input signal from a bill entry 60, the PTS terminal 1700 transmits inserted currency information included in the input signal to the game controller 70 via the communication interface 82. When the IC card is inserted into the card insertion slot, the PTS terminal 1700 transmits the balance information stored in the IC card to the game controller 70 via the communication interface 82. The PTS terminal 1700 writes credit data to the IC card inserted into the card insertion slot based upon the control signal received from the game controller 70 via the communication interface 82.

The game controller 70 can transmit a signal to the display controller 170 by using a known communication protocol and communication connection. For example, the game controller 70 transmits a signal indicating whether the current state is a reception permission state of various buttons to the display controller 170.

An amount meter 180 stores an integrated value at each game time point of the BET game value (cash, first point, second point (details will be described later)), and an integrated value of the prize amount at each game time point, and if necessary, the stored integrated values can be outputted to outside via an output I/F 181. Each integrated value stored in the amount meter 180 is outputted to the PTS terminal 1700 in response to a request from the PTS terminal 1700 (details will be described later).

[Circuit Configuration of PTS Terminal]

Next, a configuration of a circuit provided in the PTS terminal 1700 will be described with reference to FIG. 5.

A PTS controller 1750 that controls the PTS terminal 1700 includes a CPU 1751, a ROM 1752, and a RAM 1753.

The CPU 1751 performs the execution control of each component of the PTS terminal 1700, and executes or computes various programs stored in the ROM 1752. For example, the CPU 1751 executes a credit update program to update the credit related data stored in the IC card 1500.

The ROM 1752 is formed of a memory device such as a flash memory, and the like, and stores permanent data to be executed by the CPU 1751. For example, the ROM 1752 stores the credit update program that rewrites the credit related data stored in the IC card 1500, an interlocking performance control program to be executed in response to a request from a bonus server (not illustrated), and a notification program to be executed in response to a request (notification information, and the like) from the hotel server 500.

The RAM 1753 temporarily stores data necessary when various programs stored in the ROM 1752 are executed.

An external storage device 1754 is, for example, a storage device such as a hard disk device, and stores a program to be executed by the CPU 1751 and data used by the program to be executed by the CPU 1751.

A server interface (I/F) 1755 implements data communication between a server such as the hotel server 500 or the bonus server (not illustrated) and the PTS terminal 1700. A gaming machine I/F 1756 implements data communication between the game controller 70 of the slot machine 1010 and the PTS terminal 1700, and a predetermined protocol may be used for the data communication.

The PTS terminal 1700 is connected to the bill entry 60 via a bill validator I/F 1757 and connected to a settlement machine (not illustrated) via a settlement machine I/F 1758, and can transmit and receive data as necessary.

A USB control part 1759 determines whether to supply power from a power supply unit 1760 to the USB terminal 1737 and can charge the USB terminal 1737 when a predetermined condition is satisfied. The player can charge an electronic device by connecting the electronic device to the USB terminal 1737 when the predetermined condition is satisfied.

In order to cause the light emitting plate on the upper side of the LCD 1719 to emit light in response to a notification request from the hotel server 500, an interlocking performance start request from the bonus server (not illustrated), and the like, a light emitting part LED drive part 1761 controls the full color LED 1721a to be turned on at a predetermined timing, and in order to cause the light emitting plate on the lower side of the LCD 1719 to emit light, the light emitting part LED drive part 1761 controls the full color LED 1721b to be turned on at a predetermined timing.

An LCD control part 1762 is controlled so that member information, information for the member, and the like are displayed on the LCD 1719, and data read from the IC card 1500 and data inputted by the player are displayed. The LCD 1719 includes a touch panel function, and when the touch panel is operated by the player, a predetermined signal is transmitted to the CPU 1751.

A home button 1722 is provided near the LCD 1719 and is a button for shifting a screen displayed on the LCD 1719 to a predetermined upper screen. When the home button 1722 is pressed by the player, an operation of the player is transmitted to the CPU 1751, after which the CPU 1751 transmits a command to the LCD control part 1762 so as to update the display of the LCD 1719 according to the operation.

An IC card control part 1763 controls insertion and discharge of the IC card 1500, and writing of the credit data. The IC card control part 1763 includes an IC card reader and writer (R/W) control part 1763a, an IC card receiving and discharge control part 1763b, and an LED control part 1763c.

The IC card R/W control part 1763a controls the card unit 1741, thereby updating the credit related data (game value information) stored in the IC card 1500. When the IC card 1500 is newly issued, the credit related data corresponding to the settled amount are stored in the IC card 1500 to be newly issued. The card unit 1741 includes an antenna part for reading or writing data from or to the IC card 1500 by NFC, and the like.

The card unit 1741 includes functions of an IC card reader for reading the information stored in the IC card 1500 and of an IC card writer for writing the information to the IC card 1500, but may include either one of the above-described functions as necessary.

The IC card receiving and discharge control part 1763b controls receiving and discharge of the IC card 1500. When the IC card 1500 is inserted into the card insertion slot 1730 by a player, the IC card is controlled to be held in the card unit 1741 while the player executes a game. After the credit related data are written to the IC card 1500 at the time of settlement, the IC card 1500 is controlled to be discharged therefrom. When the eject button 1732 is pressed, the IC card 1500 is discharged.

When the IC card 1500 is newly issued, the IC card 1500 is newly taken out of the card stacker 1742, and then the IC card 1500 is supplied to the card unit 1741 in order to store the credit related data.

The LED control part 1763c is controlled so that the LED (full color LED 1731) provided near the card insertion slot 1730 of the card unit 1741 is turned on and the LED (red LED 1733) provided near the eject button 1732 is turned on.

A touch unit control part 1764 controls data transmission and reception according to a touch operation of the IC card 1500, a mobile phone, a smart phone, and the like. The touch unit control part 1764 includes a non-contact R/W control part 1764a and an LED control part 1764b.

The non-contact R/W control part 1764a determines whether the IC card 1500 or the mobile phone approaches a predetermined distance (for example, a touch operation is performed) in the touch unit 1745, and when the IC card 1500 or the mobile phone approaches the predetermined distance, the non-contact R/W control part 1764a acquires a reading result, and the like from the touch unit 1745. The touch unit 1745 includes an antenna part for transmitting and receiving data to and from the IC card 1500 and the mobile phone by NFC, and the like.

The touch unit 1745 includes functions of an IC card reader for reading information stored in the IC card 1500 and the mobile phone, and an IC card writer for writing information to the IC card 1500 and the mobile phone, but may include either one of the above-described functions as necessary.

The LED control part 1764b controls the LEDs 1746 disposed at four corners of the front surface of the touch unit 1745 and lights the LEDs 1746 at a predetermined timing.

A DSP 1765 receives voice data acquired from microphones 1715 and 1717, performs predetermined voice processing, and transmits the voice data to the CPU 1751. The DSP 1765 transmits the received voice data to speakers 1707 and 1709. The DSP 1765 outputs the received voice to the headphone with respect to the audio terminal 1738 connected to the headset, processes the voice received from the microphone, and transmits the processed voice to the CPU 1751. Here, a schematic configuration is illustrated and an A/D converter, a D/A converter, an amplifier, and the like are omitted.

A camera control part 1766 acquires an image of a player, and the like captured by the human body detection camera 1713, performs predetermined image processing as necessary, and transmits the processed data to the CPU 1751. The data are transmitted to, for example, the hotel server 500, and the like via the server I/F 1755.

The camera control part 1766 transmits imaging information captured by the human body detection camera 1713 to the hotel server 500, and the like in response to an instruction from the hotel server 500.

In the slot machine 1010 of the embodiment (PTS terminal 1700), cash, points, and the like are included as a game value which can be inserted for playing a game. The cash is inserted into the bill entry 60 of the PTS terminal 1700, and information (cash insertion amount information) indicating the type (cash) and the amount of the game value is transmitted from the PTS terminal 1700 to the game controller 70 of the gaming machine 1010. The game controller 70 stores the information received from the PTS terminal 1700 in the memory of the amount meter 180. The point is read out from the information card inserted into the card unit 1741 of the PTS terminal 1700, and information (point insertion amount information) indicating the type (first or second point) and the amount of the game value is transmitted from the PTS terminal 1700 to the game controller 70 of the gaming machine 1010. The game controller 70 stores the information received from the PTS terminal 1700 in the memory of the amount meter 180. The point is a point which is distributed for promotion of a casino, and the like, and a player can use the point in the slot machine 1010 (PTS terminal 1700) in a state where the point is stored in his or her own information card. In the point, there are a limited point (first point) that can be used only for playing a game, and an unlimited point (second point) that can be used for other than playing the game (for example, usable for various services in the facility). These points are stored so as to be distinguishable in the corresponding storage area of the information card for each type of the point. Accordingly, when the information card is inserted into the card unit 1741 of the slot machine 1010 (PTS terminal 1700), any of the first and second points can be selectively used. The selection thereof is configured to be selectable, for example, on the LCD touch panel 1719 of the PTS terminal 1700. In the embodiment, it is assumed that both of the first point and the second point cannot be treated as cash equivalent, and in principle, cash conversion is not possible.

Here, every time the game is started, the amount meter 180 of the slot machine 1010 stores an integrated amount (total coin in credits) which is an integrated value at each game time point with respect to a game value (cash) BET for executing the game in the gaming machine 1010; an integrated amount (total restricted amount played) which is an integrated value at each game time point with respect to a BET game value (first point); and an integrated amount (total non-restricted amount played) which is an integrated value at each game time point with respect to a BET game value (second point). These integrated amounts mean, for example, the respective integrated amounts of the above-described three types after the gaming machine 1010 is powered on or the respective integrated amounts of the above-described three types after a predetermined reset operation is performed, and, at the start of each game, the amount meter 180 updates (integrates) these values by adding the amount to the integrated value up to that time for each type of game value BET on one new game.

The amount meter 180 stores an integrated amount (total coin out credits) which is an integrated value at each game time point at the end of each game with respect to the amount of prize awarded to the player as a result of the game in the gaming machine 1010. The integrated payout amount means, for example, an integrated payout amount after the power source of the gaming machine 1010 is turned on or an integrated payout amount after a predetermined reset operation is performed, and, at the end of each game, the amount meter 180 updates (integrates) these values by adding the amount of the prize awarded in the new one game to the integrated value up to that time. The type of game value awarded to the player as the prize is one type (for example, cash), and when the game value is inserted, the game value is classified and stored for each type of the game value (for example, cash, first point, second point), whereas when the prize is paid out, the type thereof is integrated without classifying the type. The “each game time point” means a predetermined time point such as a game start time and a game end time.

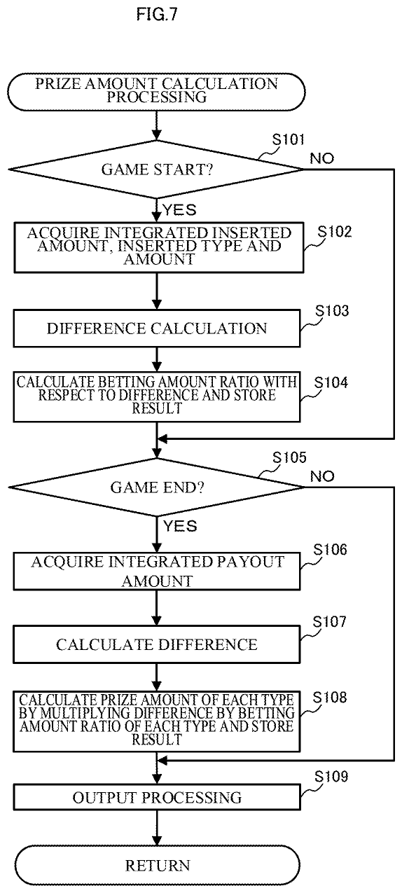

The PTS terminal 1700 receives these integrated values (integrated inserted amount of various game values inserted for playing the game in the slot machine 1010 (PTS terminal 1700) and integrated payout amount of the game value, which is paid out as a result of the game, for which the type of the game value is not classified) from the slot machine 1010 for each game and stores the received integrated values in the RAM 1753. Then, by using the received information, a dividend ratio of each type of the inserted game value to the payout amount of each game (dividend amount ratio obtained by investing cash which accounts for the payout amount (prize amount), a dividend amount ratio obtained by investing the first point included therein, and a dividend amount ratio obtained by investing the second point included therein) is calculated and stored. Based upon the ratio, the payout amount of each type of the game value corresponding to the dividend amount ratio of each type of the game value inserted in the payout amount (prize amount) of each game is calculated and outputted (prize amount calculation processing which will be described later in FIG. 7).

[Content of Program Executed in Slot Machine]

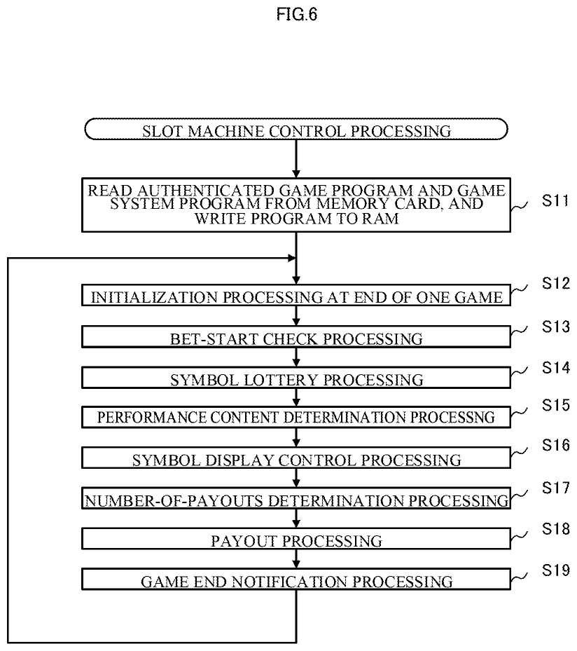

Next, a program to be executed by the slot machine 1010 will be described with reference to FIG. 6. The slot machine 1010 transmits various kinds of game information to the hall management server at an appropriate timing.

[Main Control Processing]

First, main control processing will be described with reference to FIG. 6. First, when power is supplied to the slot machine 1010, the game controller 70 reads the game program and the game system program, and writes the read game program and game system program to the RAM (step (hereinafter abbreviated as S) 11).

Next, the game controller 70 performs initialization processing at the end of one game (S12). For example, data that become unnecessary for each game in the work area of the RAM such as the number of BETs and symbols determined by lottery are cleared.

Next, the game controller 70 performs bet⋅start check processing which will be described later (S13). In S13, the input check of the BET switch 34S and the spin switch 46S is performed. In the embodiment, when the IC card 1500 (member information card or non-member information card) is inserted into the card insertion slot 1730, the game value is read from the inserted IC card 1500 and is set to a number-of-credits counter, thereby it is possible to play the game within a range of the set number of credits. When the IC card 1500 is not inserted thereinto, the number-of-credits counter is set in accordance with an amount of a currency inserted into the bill entry 60, thereby the game can be played.

Next, the game controller 70 performs symbol lottery processing (S14). In S14, a stop-scheduled symbol is determined based upon a random numerical value for symbol determination.

Next, the game controller 70 performs performance content determination processing (S15). The main CPU extracts a random numerical value for the performance, and determines one of a plurality of predetermined performance contents by lottery. The contents of the performance can be determined according to a winning combination and a situation of the game in the slot machine 1010. For example, it can be configured to vary the lottery probability with respect to each performance according to the winning combination and the situation of the game in the slot machine 1010.

Next, the game controller 70 performs symbol display control processing (S16). In S16, scrolling of the five columns of pseudo reels 1151 to 1155 (first to fifth video reels) is started, and then the stop-scheduled symbol determined in the symbol lottery processing of S14 is stopped at a predetermined position (for example, the display window 1150 of the lower image display panel 1141). That is, for each reel, four symbols including the stop-scheduled symbol are displayed in the display window 1150. For example, when the stop-scheduled symbol is a symbol of a code number “10” and the symbol of code number “10” is displayed in the upper stage area, the respective symbols of code numbers “11”, “12” and “13” are respectively displayed in the upper middle stage, lower middle stage, and lower stage in the display window 1150.

Next, the game controller 70 performs number-of-payouts determination processing (S17). In S17, the number of payouts is determined based upon the combination of symbols displayed on a winning line, and is stored in a number-of-payouts counter provided in the RAM.

Next, the game controller 70 performs payout processing (S18). The game controller 70 adds a value stored in the number-of-payouts counter to the number-of-credits counter provided in the RAM. Here, for example, when a player presses a CASHOUT button, the CASHOUT switch 32S which detects a fact that the CASHOUT button is pressed outputs a signal to the main CPU (not illustrated) of the game controller 70, and the number of credits stored in the IC card 1500 held in the card unit 1741 is updated to the value of the number-of-credits counter. That is, when the information card (member information card or non-member information card) is inserted into the card unit 1741, the number of credits (game value) read from the inserted information card (IC card 1500) is written to the number-of-credits counter; the game (BET) is played according to the written number of credits; and the result in which the dividend is added according to the result of the game and the value of the number-of-credits counter which is formed of the number of credits as a result of subtracting the number of credits for the number of BETs are written as the balance information of the game value to the IC card 1500 to be finally paid out, thereby the balance information of the IC card 1500 is updated and the IC card 1500 is discharged from the card insertion slot 1730. When the game is played by a currency inserted into the bill validator 1022 in a state where the IC card 1500 is not inserted into the card unit 1741, a dividend given to the player as a result of the game and a balance of the inserted currency are stored in the number-of-credits counter, after which the dividend and the balance are written as the balance information to the unused IC card 1500 prepared in the card stacker 1742 according to the operation of the CASHOUT button. Next, the IC card 1500 is discharged from the card insertion slot 1730 as the non-member information card.

Next, the game controller 70 performs game end notification processing (S19). In S19, the main CPU transmits data indicating that one game ends (data including game end date data capable of specifying the game end date and time) to the PTS terminal 1700 (together with the identification code, and the like of the IC card 1500 when the IC card 1500 and the like are inserted thereinto and thus the player can be identified). The PTS terminal 1700 transmits the aforementioned data to the hotel server 500, and the hotel server 500 stores the data. In response thereto, the bonus server 11 performs the lottery of the bonus game. When the processing of S19 is completed, the processing is returned to the processing of S12 and the unit game is repeated.

[Prize Amount Calculation Processing]

FIG. 7 is a flowchart illustrating a processing procedure of prize amount calculation processing executed by the PTS controller 1750 of the PTS terminal 1700.

The PTS controller 1750 determines whether a game start signal indicating the start of a unit game transmitted from the gaming machine 1010 is received in step S101. When a positive result is obtained in step S101, the result indicates that a new game is started in the gaming machine 1010; the PTS controller 1750 shifts the processing from step S101 to step S102; and the PTS controller 1750 acquires insertion information at the start time point of the new game transmitted from the gaming machine 1010 together with the game start signal, and then stores the game start signal and the acquired insertion information in the RAM 1753.

The insertion information is information including the total coin in credit, the total restricted amount played, and the total non-restricted amount played which are described above. Continuously in step S102, the PTS controller 1750 calculates a difference between the information stored in the RAM 1753 and the corresponding information stored in the RAM 1753 at the start time of the previous game (S103), thereby it is possible to obtain the inserted amount of the three types of game values in one game. In step S104, based on the difference calculated in step S103 (that is, the amount of each type of the game value inserted for one game), the ratio of the inserted amount of each type to the total amount of all types of the game values inserted for the one game (betting amount ratio of each game value in one game) is calculated, respectively. Then, the calculated ratio of each type of the game media (betting amount ratio) is stored in the RAM 1753. In the embodiment, from a difference of the integrated values (each amount inserted for one game) with respect to the two game values (first point and second point) among the three game values (cash, first point, and second point) and a total inserted amount of all types per one game (total amount of cash, first point, and second point inserted for one game), the ratio of total inserted amount (“total restricted amount played/total coin in” and “total non-restricted amount played/total coin in”) of the two game values (first point and second point) to the total inserted amount of all the game values inserted for one game is calculated; and cashable wager rate is calculated by a difference between a result in which these ratios are added and “1”, but is not limited thereto. For example, the inserted amounts of three game values (cash, first point and second point) in one game may be calculated from the difference between the respective integrated values, and the ratio of the difference to the total inserted amount may be set to the insertion ratio of each game value (ratio of each game value to the total inserted amount). When the total of the ratio of the two game values (first point and second point) to the total inserted amount (“total restricted amount played/total coin in” and “total non-restricted amount played/total coin in”) exceeds “1”, it becomes an illegal value, and the ratio of the inserted cash is set to “1”, and the insertion ratio of the first point and the second point is set to “0”.

After performing the processing in step S104, or when a negative result is obtained in the above-described step S101, the PTS controller 1750 shifts the processing to step S105 to determine whether a game end signal indicating the end of the unit game transmitted from the gaming machine 1010 is received.

When a positive result is obtained in step S105, the result indicates that the unit game (one game) is terminated in the gaming machine 1010, and the PTS controller 1750 shifts the processing from step S105 to step S106, acquires the total coin out credits at the time of end transmitted from the gaming machine 1010 together with the game end signal, and stores the acquired integrated payout amount and game end signal in the RAM 1753.

Continuously, in S107, the PTS controller 1750 calculates a difference between the information stored in the RAM 1753 and the corresponding information stored in the RAM 1753 at the end of the previous game, and in step S108, by multiplying the difference calculated in step S107 (that is, the prize amount generated in one game) by the ratio (betting amount ratio) of each type of the game value inserted for one game calculated in the above-described step S104, the prize amount of each type of the inserted game value among the prize amounts generated in one game is calculated, and the calculated result is stored in the RAM 1753.

Next, in step S109, the PTS controller 1750 outputs the calculated prize amount of each type of the game value in response to a request from outside. Specifically, the prize amount (or betting amount ratio) of each type of the game value is outputted to a server which is a request source in response to a request from a management server (for example, the hotel server 500, and the like of a casino where the plurality of slot machines 1010 are installed) to which the slot machine 1010 is connected. Accordingly, in the management server, each slot machine 1010 outputs the prize amount with respect to the amount BET by cash, the prize amount with respect to the amount BET by the first insertion point, and the prize amount with respect to the amount BET by the second insertion point among the prize amounts generated in one game. Then, the PTS controller 1750 waits for the start of the next game.

Thus, by executing the prize amount calculation processing in the PTS terminal 1700, it is possible to calculate a breakdown of each type of the BET game value among the prize amounts generated in each game. For example, described is a case where with respect to the integrated value of the BET amount of cash, the integrated value of the BET amount by the first insertion point, and the integrated value of the BET amount by the second insertion point, a difference before and after one game is obtained and a difference between the integrated values of the prize amount before and after one game is obtained, thereby, for example, it can be seen that 1 dollar in cash, 2 dollars with the first insertion point, and 3 dollars with the second insertion point are BET for one game, and the prize amount of 60 dollars in one game is generated. Here, it can be seen that the total amount BET for the one game is 6 dollars from the results thereof. As the breakdown of 6 dollars, 1/6 becomes a betting amount ratio in which cash is BET; 2/6 becomes a betting amount ratio in which the first insertion point is BET; and 3/6 becomes a betting amount ratio in which the second insertion point is BET. By multiplying each of these betting amount ratios by 60 dollars which is the prize amount, 10 dollars out of the prize amount of 60 dollars is the prize amount for the BET in cash; 20 dollars out of the prize amount of 60 dollars is the prize amount for the BET with the first insertion point; and 30 dollars out of the prize amount of 60 dollars is the prize amount for the BET with the second insertion point. With respect to the betting amount ratio of cash, 1/6 may be calculated by subtracting an addition result of 2/6 and 3/6 from “1” by using 2/6 which is the betting amount ratio of the first insertion point and 3/6 which is the betting amount ratio of the second insertion point, and one betting amount ratio among the three (plurality of) game values can be obtained from the betting amount ratio of the other game values and the total inserted amount.

Thus, it is possible to calculate the breakdown of each ratio of the BET game value in the result of the game generated uniformly as the prize amount.

In the above-described embodiment, the case in which the cash, the first insertion point, and the second insertion point are used as the game value to be provided (BET) for the game is described, but the type of the game value is not limited thereto, and can be applied to a case in which various game values are provided to the game. For example, when game value information other than the first and second points is stored as the game value information stored in the IC card 1500, the ratio of each game value to the prize amount and the amount thereof can be calculated by acquiring the integrated inserted value for the game. Specifically, as described above with respect to the IC card 1500, when the first game value information is stored in the first storage area AR1 of the IC card 1500; the second game value information is stored in the second storage area AR2; the third game value information is stored in the third storage area AR3; and the fourth game value information is stored in the fourth storage area AR4, even when the pieces of first, second, third, and fourth game value information are provided for the game, in the same manner as that of the above-described embodiment, the integrated inserted value provided (BET) to the game is stored for each type of the game value information provided to the game (type of whether it is the first game value information, the second game value information, the third game value information, or the fourth game value information); based upon the difference between the integrated inserted values before and after the game (that is, the amount of each type of the game value inserted for one game), the ratio (the betting amount ratio of each game value in one game) of the inserted amount of each type to the total amount of all types of the game values (first to fourth game value information) inserted for one game is calculated respectively; and based upon the calculated ratio of each type of the game value (the betting amount ratio), it is also possible to obtain the ratio in the dividend of one game and the prize amount of each type of the game value (first to fourth game value information) corresponding to the ratio.

In the above-described embodiment, the integrated value of each of the three game values (cash, first point, and second point) stored in the amount meter 180 of the gaming machine 1010 for each game and the integrated value of the prize amount are acquired for each game in the PTS terminal 1700, and the breakdown of each game value in the prize amount is calculated based on each difference. However, when the result of one game is not obtained in the gaming machine 1010 (for example, the sum of the inserted amounts of three game values in one game (the sum of the differences of each integrated value before and after one game) becomes “0”), each integrated value of the previous inserted amount is maintained without executing the prize amount calculation processing (FIG. 7), and is summed up with an integrated value obtained at the next game, thereby calculating two games as one time. Thus, even when the betting for two games is put together at the time of high-speed play, the prize amount ratio can be calculated.

While the embodiment of the present invention is described, the embodiment thereof is merely described with a specific example and does not particularly limit the present invention, and a specific configuration of each device, and the like can be appropriately changed in design. The effects described in the embodiment of the present invention are those merely enumerating the most suitable effects resulting from the present invention, and the effects of the present invention are not limited to those described in embodiment of the present invention.

In the above-described detailed descriptions, a characteristic part is mainly described so as to more easily understand the present invention. The present invention is not limited to the embodiment described in the detailed descriptions, but can be also applied to other embodiments and the scope of application thereof is varied. The terminology and the phase used in the present specification are used to accurately describe the present invention, and are not used to limit the interpretation of the present invention. It may be easy for those skilled in the art to reconsider other configurations, systems, methods, and the like included in the concept of the present invention from the concept of the present invention described in the present specification. Therefore, the description of the scope of the claims shall be deemed to include an equivalent configuration without departing from the scope of the technical ideas of the present invention. An object of the abstract is to enable the patent office, a general public institution, and an engineer belonging to the technical field who is not familiar with patents, legal terms, or technical terms to quickly determine the technical content of the present application and nature thereof with a simple investigation. Therefore, the abstract is not intended to limit the scope of the invention to be evaluated by the descriptions of the scope of the claims. In order to fully understand the object of the present invention and the specific effect thereof, it is desirable that the literatures already disclosed are interpreted with due consideration.

The above-described detailed descriptions include the processing executed by a computer. The above descriptions and expressions are intended to help those skilled in the art to understand most efficiently. In the present specification, each step used to derive one result should be understood as processing that is not self-contradictory. In each step, transmission and reception, recording, and the like of an electrical or magnetic signal are performed. In the processing in each step, while such a signal is represented with bits, values, symbols, characters, terms, numbers, and the like, it should be noted that these are merely used for the convenience of the descriptions. While the processing in each step may be described with expressions common to human behavior, the processing described in the present specification is basically performed by various devices. Other configurations required for performing each step become obvious from the above descriptions.

### PARTS LIST

100: casino system
500: hotel server
600: cashier
601: device for issuing a game chip
1010A, 1010B: slot machine
1500: IC card
1600: game chip
1700: PTS terminal
2010A, 2010B: game table

What is claimed is:

1. A gaming machine capable of playing a game according to an inserted game value, the machine comprising:
an insertion part capable of inserting a plurality of types of game values into a game;
an insertion information storage part configured to store the type of the inserted game value and an integrated value of an inserted amount of each type at each game time point as insertion information;
a game execution part configured to execute the game according to the inserted game value;
a payout information storage part configured to store an integrated value of a prize amount at each game time point as payout information;
a prize amount ratio calculation part configured to calculate a ratio of each type of the inserted game value to a prize amount of each game executed in the gaming machine based upon the insertion information and the payout information; and
an output part configured to output information on the calculated prize amount ratio.

2. The gaming machine according to claim 1, further comprising:
a selection part capable of selecting one or more types of the inserted game values and selecting an inserted amount for each of the selected types, wherein
the prize amount ratio calculation part stores an integrated value of an amount of each type at each game time point for each type of the game value selected in the selection part as the insertion information.

3. The gaming machine according to claim 1, wherein
the prize amount ratio calculation part calculates the sum of the inserted amounts of all types of the game values inserted for one game and a prize generated in the one game based upon a difference between integrated values of the inserted game value before and after the one game, and a difference between integrated values of the prize amount before and after the one game, and
the prize amount ratio calculation part calculates a ratio of each type of the inserted game value to the prize amount of the game executed in the gaming machine based upon the calculated sum of the inserted amounts of all types of the game value, the prize amount, and the insertion information.

4. The gaming machine according to claim 3, wherein
the prize amount ratio calculation part calculates an amount of each type of the inserted game value which accounts for the prize amount of the game by multiplying the calculated ratio of each type of the inserted game value to the prize amount of the game executed in the gaming machine by the sum of the inserted amounts of all types of the game values inserted for the one game.

5. An information processing device connected to be capable of transmitting and receiving information to and from a gaming machine capable of playing a game according to an inserted game value, the device comprising:
an insertion part capable of inserting a plurality of types of game values into a game;
a prize amount ratio calculation part configured to calculate a ratio of each type of the inserted game value to a prize amount of each game executed in the gaming machine based upon the type of the inserted game value and an integrated inserted value of an inserted amount of each type at each game time point, and an integrated payout value of a prize amount at each game time point; and
an output part configured to output information on the calculated prize amount ratio.

6. A game system, comprising
a gaming machine capable of playing a game according to an inserted game value, and
an information processing device connected to be capable of transmitting and receiving information to and from the gaming machine, wherein
the gaming machine includes
a game execution part configured to execute a game, and
an interface capable of transmitting and receiving information to and from the information processing device, and
the information processing device includes
an insertion part capable of inserting a plurality of types of game values into a game,
a prize amount ratio calculation part configured to calculate a ratio of each type of the inserted game value to a prize amount of each game executed in the gaming machine based upon the type of the inserted game value and an integrated inserted value of an inserted amount of each type at each game time point, and an integrated payout value of a prize amount at each game time point, and
an output part configured to output information on the calculated prize amount ratio.
